(19) United States
(12) Patent Application Publication
(10) Pub. No.: US 2013/0084902 A1
(43) Pub. Date: Apr. 4, 2013

(54) APPLICATION OF MORSE CODE OR OTHER ENCODING METHOD TO INSTANT MESSAGING AND INCOMING CALLS ON MOBILE DEVICES

(71) Applicant: PageBites, Inc., Palo Alto, CA (US)

(72) Inventor: Johan de Ruiter, Menlo Park, CA (US)

(73) Assignee: PAGEBITES, INC., Palo Alto, CA (US)

(21) Appl. No.: 13/645,140

(22) Filed: Oct. 4, 2012

Related U.S. Application Data
(60) Provisional application No. 61/543,184, filed on Oct. 4, 2011.

(51) Int. Cl. H04W 4/14

(52) U.S. Cl. 455/466

(57) ABSTRACT

A method for announcing arrival of an electronic communication in a wireless mobile device includes: (a) receiving from a wireless interface of the mobile device data corresponding to the arrival of the electronic communication; (b) processing the received data to extract therefrom identification of information, the identification information including an identity of a sender or caller; (c) encoding the extracted identification in an encoding scheme suitable for being played physically in an actuator of the mobile device; and (d) providing the encoded identification to a driver for the actuator of the mobile device. The identification information may further include a subject of the electronic communication. The encoding scheme may be, for example, a form of Morse code. The encoded identification may therefore be expressed by an alphabet represented by segments of audible tone of various durations to be played by the audio system of the mobile device. Alternatively, the encoded identification may be expressed by an alphabet represented by modulated segments of vibration of various durations to be played by a vibration generator in the mobile device.

### CROSS REFERENCE TO RELATED APPLICATIONS

The present application relates to and claims priority of U.S. provisional patent application (“Provisional Patent Application”), Ser. No. 61/543,184, entitled “Application of Morse Code or Other Encoding Method to Instant Messaging and Incoming Calls on Mobile Devices,” filed on Oct. 4, 2011. The Provisional Patent Application is hereby incorporated by reference in its entirety.

### BACKGROUND OF THE INVENTION

1. Field of the invention

The present invention relates generally to communication applications in a mobile device. In particular, the patent invention relates to user interface features that enhance instant messaging and other applications in a mobile device.

2. Discussion of the Related Art

Many mobile devices capable of receiving electronic communication (e.g., telephone calls, email messages or Short Message Service (SMS) messages) allow a user to associate a “ring tone” with a specific sender. When the electronic communication arrives from a known sender or caller, the ring tone associated with that sender or caller is played to alert the user and to announce the specific sender or caller. However, when a message or telephone call arrives from a sender or caller who has not been specifically associated with a ring tone, a generic or default ring tone is played, and the user would have to look at the mobile device's display to ascertain the identity of the sender or caller. The user would then decide if he or she should respond to the incoming message or telephone call immediately. The process of associating a sender or caller to a specific ring tone is an added burden on the user. In addition, the user needs to remember which ring tone is associated with which caller or sender. As the number of callers and senders become large for any user, this memory task becomes more difficult. Furthermore, such facility may not be available for instant messaging or other forms of communication.

### SUMMARY

According to one embodiment of the present invention, a Morse code or another encoding method may be used to enable a mobile device to alert the user of an incoming instant message or an incoming telephone call and to identify the sender or caller of the incoming instant message or the incoming telephone call. Using a method of the present invention, a user need not specifically associate a caller or sender with a ring tone to receive an alert that identifies the caller or sender.

A method for announcing arrival of an electronic communication in a wireless mobile device includes: (a) receiving from a wireless interface of the mobile device data corresponding to the arrival of the electronic communication; (b) processing the received data to extract therefrom identification of information, the identification information including an identity of a sender or caller; (c) encoding the extracted identification in an encoding scheme suitable for being played physically in an actuator of the mobile device; and (d) providing the encoded identification to a driver for the actuator of the mobile device. The identification information may further include a subject of the electronic communication. The encoding scheme may be, for example, a form of Morse code. The encoded identification may therefore be expressed by an alphabet represented by segments of audible tone of various durations to be played by the audio system of the mobile device. Alternatively, the encoded identification may be expressed by an alphabet represented by modulated segments of vibration of various durations to be played by a vibration generator in the mobile device.

The present invention is better understood upon consideration of the detailed description below.

### BRIEF DESCRIPTION OF THE DRAWINGS

FIG. 1 is a block diagram of mobile device 100 capable of providing a physical alert of an incoming electronic message, in accordance with one embodiment of the present invention.

### DETAILED DESCRIPTION OF THE PREFERRED EMBODIMENTS

The present invention provides a physical alert in a mobile device to announce the arrival of any electronic communication (e.g., a telephone call, an instant message or an email or SMS message). The physical alert may be delivered in a form that can be physically sensed by the user (e.g., audible sounds or a modulated vibration) and which encodes the identification of a sender or user, or the subject matter of the communication, specified in the electronic communication. In this detailed description, the example of an instant message is used to illustrate specific embodiments of the present invention.

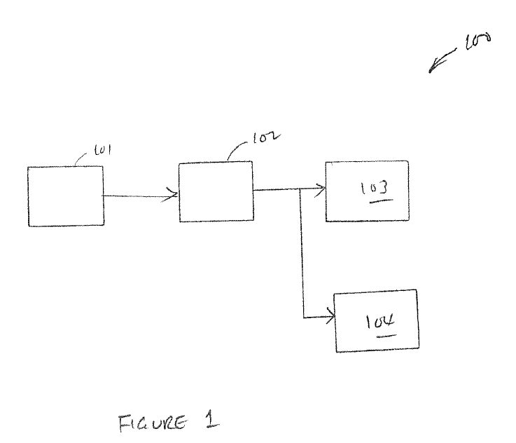

FIG. 1 is a block diagram of mobile device 100 capable of providing a physical alert of an incoming electronic communication (e.g., an instant message, an email message or a pending telephone call), in accordance with one embodiment of the present invention. As shown in FIG. 1, mobile device 100 includes wireless communication interface 101 which processes data received over a wireless communication link. In an instant messaging application, for example, the incoming message may be forwarded by a server (e.g., imo.im). When wireless communication interface 101 recognizes that the received data specify a form of electronic communication (e.g., through the protocol handler specified for the connection or socket), physical alert handler 102 is invoked. Physical handler 102 is an application program or a utility program running on the mobile device that is tasked to monitor incoming electronic communication. Physical alert handler 102 extracts from the received data identification information of the caller or sender (e.g., the name, email address or telephone number) and the subject line, if any. The extracted identification information can then be encoded, transcoded or translated into one or more of several encoding schemes by physical alert handler 102. These encoding schemes include, for example, Morse code, and are selected because the alphabet of the encoding scheme (e.g., “dot,” “dash” and space in Morse code) can be represented easily in an audible fashion or in vibration, according to user preference. In one implementation, a worker thread is created which first translates the characters in the extracted information (i.e., the letters in the Latin, Arabic, Cyrillic and Hebrew alphabets and digits 0 through 9) into a string over the Morse alphabet. In that implementation, a space in the input string may be translated into four (4) spaces. Each character in the input string—even when the character itself does not have an equivalent representation in standard Morse code—is introduced by an additional two spaces. The entire message is followed by an additional eight (8) spaces.

The dots and dashes of Morse code can be represented by short and long beeps (or sound of short and long durations) that can be played through the speaker system of the mobile device, or be expressed as vibration segments of long and short durations that can be played by the vibrator of the mobile device. The encoded identification information and the subject line may then be translated into either audible sounds or vibration segments, depending on the user's preference. The translated identification information and subject line are then forwarded to an appropriate driver. For example, as shown in FIG. 1, the translated information may be passed to audio driver 103, which then plays the sound-encoded identification information and subject information in the audio system of mobile device 100, if appropriate. The volume, frequency, duration and other variable parameter of an “audible sound” or “audible tone” may be independently changed. For example, one may direct the frequencies used to switch between frequencies distinguishable to the ordinary human ear.

Likewise, as shown in FIG. 1, the vibration segment-encoded identification and subject information are provided to driver 104 of the vibration actuator in mobile device 100 to play the information as vibration segments. In the implementation discussed above, a string expressed in the Morse alphabet is then translated into vibration segments or silence by the worker thread. In that implementation, the shortest vibration segment has a length of 125 milliseconds, and each Morse character is represented by a vibration segment that has a duration that is a multiple of the duration of the shortest segment. For example, the vibration segment for a dot is one (1) unit long (i.e., 125 millisecond), and the vibration segment for a dash is three (3) units long (i.e., 375 milliseconds). Every vibration segment is accompanied by a sleep command that lasts 1 unit length (i.e., 125 milliseconds) longer than the vibration segment, thus inserting an imaginary space. Every space is represented by a unit length of silence. This scheme loosely follows the timing specified in the standardized International Morse code. The 125 millisecond minimum duration was selected to allow an untrained user to be able to distinguish between a dot and a dash.

In one embodiment, to train a user to learn the implemented Morse code, an application program that provides an interactive Morse code table can be provided. Such an interactive table allows a user to select any character from the table and plays the corresponding vibration segment. Next to each character, the Morse representation may be indicated by forms that are easier to recognize (e.g., circles and rectangles). The user may feel the associated vibration to become familiar with the vibration representing the selected Morse character.

In this manner, the identification of the sender or caller, or the subject matter of the incoming communication may therefore by conveyed to the user without requiring the user to read the graphical display of mobile device 100, which may require, for example, that the user retrieve the mobile device from his or her pocket or from a handbag. The vibration mode is particularly useful to prevent an incoming message from interrupting a meeting, unless the identification information from the silent announcement indicates to the user the urgency of the message for example.

In some embodiments, where the received message is an instant message, the application can search a repository (e.g., an address book) on the mobile device, for example, to retrieve an alias for the sender and prepends the alias in the announcement. Similarly, for a message coming from a group chat, the identification of the message includes the name of the group. In that instance, the application may first announce the group, followed by the name of the sender.

One embodiment is implemented in a cellular telephone. The Java code for the implementation is included in Appendix A for reference by those of ordinary skill in the art.

The above detailed description is provided to illustrate specific embodiments of the present invention and is not intended to be limiting. Numerous variations and modifications within the scope of the invention are possible.

We claim:

1. A method for announcing arrival of an electronic communication in a wireless mobile device, comprising:
receiving from a wireless interface of the mobile device data corresponding to the arrival of the electronic communication;
processing the received data to extract therefrom identification of information, the identification information including an identity of a sender or caller;
encoding the extracted identification in an encoding scheme suitable for being played physically in an actuator of the mobile device; and
providing the encoded identification to a driver for realization at the actuator of the mobile device.

2. The method of claim 1, wherein the identification information further comprises a subject of the electronic communication.

3. The method of claim 1, wherein the encoding scheme comprises Morse code.

4. The method of claim 3, wherein the actuator comprises a speaker and wherein the encoded identification is expressed by an alphabet represented by segments of audible tone of various durations.

5. The method of claim 3, wherein the actuator comprises a vibration generator and wherein the encoded identification is expressed by an alphabet represented by modulated segments of vibration of various durations.
